(19) United States
(12) Patent Application Publication
(10) Pub. No.: US 2006/0022480 A1
(43) Pub. Date: Feb. 2, 2006

(54) Cooking apparatus and control method thereof

(75) Inventors: Kwang Keun Kim, Seoul-City (KR); Seok Weon Hong, Yongin-City (KR); Yu Jeub Ha, Suwon-si (KR); Hyun Suk Kim, Yongin-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/120,964

(22) Filed: May 4, 2005

(30) Foreign Application Priority Data
Jul. 30, 2004 (KR) 2004-60319

(51) Int. Cl. B62D 33/03

(52) U.S. Cl. 296/50

(57) ABSTRACT

A cooking apparatus that is capable of automatically reading a bar code when the bar code approaches a bar-code reader and a method of controlling the same. The cooking apparatus includes a bar-code reader to read a bar code, an object-sensing unit to sense an object around the bar-code reader, and a control unit to perform a controlling operation such that the bar-code reader enters a standby mode when the object is sensed by means of the object-sensing unit.

### CROSS-REFERENCE TO RELATED APPLICATIONS

This application claims the benefit of Korean Patent Application No. 2004-60319, filed on Jul. 30, 2004 in the Korean Intellectual Property Office, the disclosure of which is incorporated herein by reference.

### BACKGROUND OF THE INVENTION

1. Field of the Invention

The present invention relates to a cooking apparatus, and, more particularly, to a cooking apparatus that is capable of reading a bar code attached to a food package to cook the food therein, and a method of controlling the same.

2. Description of the Related Art

Generally, cooking apparatuses are devices that cook foods using various heating sources. On the basis of heating sources, the cooking apparatuses are classified into several types of cooking apparatuses. For example, a microwave oven is a cooking apparatus that cooks foods using microwaves. In the conventional microwave oven, a user directly inputs cooking time, cooking mode, and the kinds of food to be cooked through the use of a key input unit formed at the front panel of the microwave oven. In a conventional microwave, it is necessary that the user manually input cooking information. Consequently, appropriate cooking conditions are not easily and conveniently set.

In order to solve the above-mentioned problem, a microwave oven having a bar-code reader has been developed that is capable of cooking foods on the basis of the cooking information read by the bar-code reader. Such a microwave oven is disclosed in Korean Unexamined Patent Publication No. 2001-0010530 and Korean Unexamined Patent Publication No. 1999-0074607.

The conventional microwave oven having the bar-code reader includes a cooking chamber disposed in an oven body, a built-in bar-code reader disposed at the front panel of the oven body or a charge-coupled display-type or pen-type bar-code reader connected to the oven body via a cable, a display unit that displays an operation of the microwave oven, an input unit having a plurality of input buttons, and a magnetron that generates microwaves to be supplied to the cooking chamber.

To perform a cooking process in the conventional microwave oven having the bar-code reader, a user presses an operation button of the bar-code reader to turn the bar-code reader on, and brings a bar code attached to a food package to the bar-code reader to read the bar code. The read bar code is interpreted, and a cooking process is performed on the basis of the interpreted cooking condition.

In the conventional microwave oven having the bar-code reader, however, it is necessary that the user manually press the operation button of the bar-code reader to read the bar code, which is inconvenient.

### SUMMARY OF THE INVENTION

Accordingly, it is an aspect of the present invention to provide a cooking apparatus having a bar-code reader that is capable of automatically reading a bar code as the bar code approaches the bar-code reader and a method of controlling the same.

Additional aspects and/or advantages of the invention will be set forth in part in the description which follows and, in part, will be obvious from the description, or may be learned by practice of the invention.

The foregoing and/or other aspects, of the present invention are achieved by providing a cooking apparatus including a bar-code reader to read a bar code, an object-sensing unit to sense an object around the bar-code reader, and a control unit to perform a controlling operation of the cooking apparatus, wherein the bar-code reader is turned on and enters a standby mode when the object is sensed by the object-sensing unit.

Another aspect of the present invention is achieved by providing a method including sensing an object around a bar-code reader, and allowing the bar-code reader to be turned on and to enter a standby mode when the object is sensed around the bar-code reader.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1A is a front view of a microwave oven having a built-in bar-code reader according to an embodiment of the present invention;

FIG. 1B is a front view of a microwave oven having an external bar-code reader according to another embodiment of the present invention;

FIG. 2 is a block diagram of the microwave oven shown in FIGS. 1A and 1B; and

FIG. 3 is a flowchart showing an operation of the microwave oven shown in FIG. 2.

### DETAILED DESCRIPTION OF THE PREFERRED EMBODIMENTS

Reference will now be made in detail to the embodiment of the present invention, examples of which are illustrated in the accompanying drawings, wherein like reference numerals refer to like elements throughout. The embodiment is described below to explain the present invention by referring to the figures.

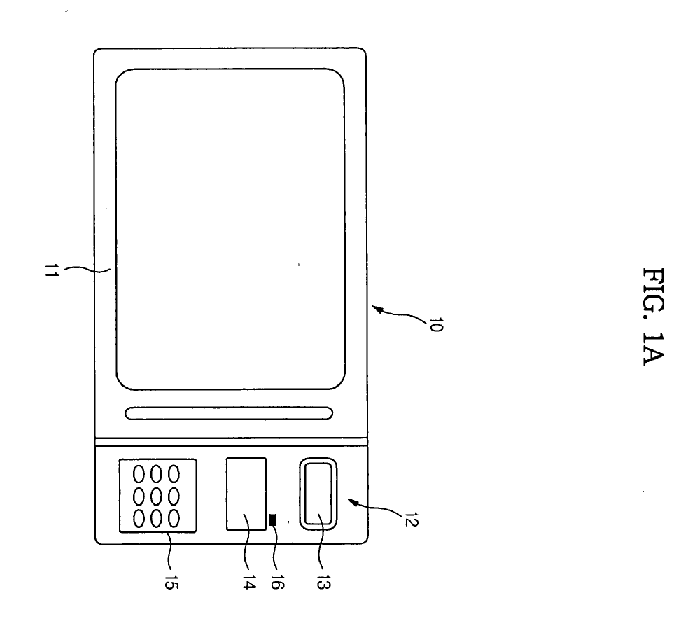

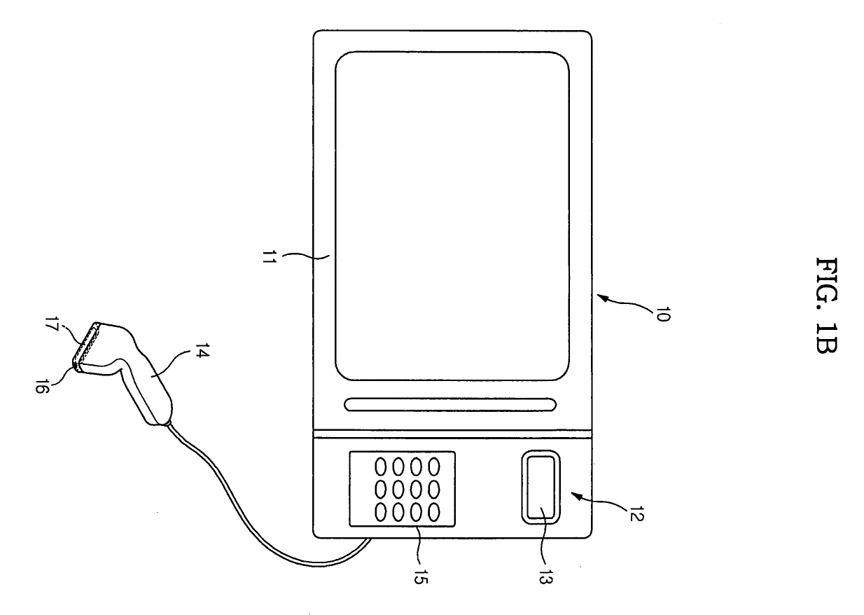

In FIG. 1A, a microwave oven according to an embodiment of the present invention includes a door 11 disposed in front of an oven body 10, and a front panel 12 disposed at the right side of the door 11.

The front panel 12 includes a display unit 13 disposed at the upper part thereof to display an operation of the microwave oven, a built-in bar-code reader 14 disposed below the display unit 13 to read a bar code, a proximity sensor 16 disposed adjacent to the bar-code reader 14 to sense the presence of an object within a predetermined distance, and an input unit 15 disposed below the bar-code reader 14. The input unit 15 including a plurality of input buttons.

The proximity sensor 16 senses the presence of an object within a predetermined distance from the proximity sensor 16. The proximity sensor 16 may be an infrared sensor, an ultrasonic sensor or any other sensor which is well known in the art. The distance at which the proximity sensor 16 senses the presence of the object may vary depending on the performance of the sensor. In this embodiment, a sensor having a detection distance of approximately 15 cm is preferably adopted.

According to the present invention, the bar-code reader 14 is automatically turned on to read a bar code when the bar code printed on a food package approaches the bar-code reader 14. The proximity sensor 16 is preferably disposed adjacent to the bar-code reader 14. In a microwave oven having a built-in bar-code reader 14 as shown in FIG. 1A, the proximity sensor 16 is disposed at the front panel 12 adjacent to the bar-code reader 14. FIG. 1B illustrates a microwave oven having an external bar-code reader 14, such as a charge-coupled display-type or pen-type (not shown) bar-code reader that is connected to the oven body 10 via a cable, where the proximity sensor 16 is preferably disposed at the external bar-code reader 14 adjacent to a reading window 17.

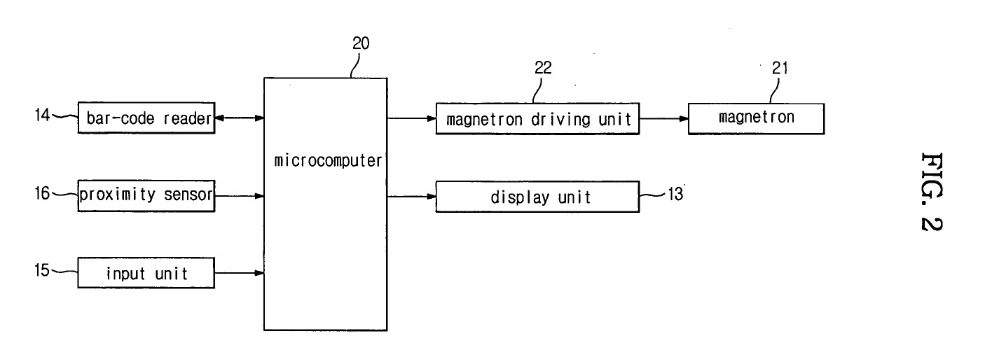

In FIG. 2, the microwave oven as shown in FIGS. 1A and 1B, further include a magnetron-driving unit 22 to drive a magnetron 21 that generates microwaves to be supplied to a cooking chamber, and a microcomputer 20 to automatically turn the bar-code reader 14 on when an object is sensed by the proximity sensor 16, to interpret a bar code read by the bar-code reader 14, and to control the respective components of the microwave oven.

The microcomputer 20 stores interpreting rules to interpret the bar code as is indicated in Table 1. Specifically, the interpreting rules stored in the microcomputer 20 determine the cooking information each line of the bar code stores, and the detailed contents of the cooking information corresponding to the value of the read bar code.

TABLE 1

| Bar code data | Cooking mode | Cooking time | Power level |
|---|---|---|---|
| Number of bits | Two bits | Eight bits | Three bits |

The first two bits are assigned to the bar code for setting the cooking mode, the following eight bits are assigned to the bar code for setting the cooking time, and the last three bits are assigned to the bar code for setting the power level, as is indicated in Table 1. The microcomputer 20 interprets the detailed contents of the respective cooking information units on the basis of the bar code data. For example, when the read bar code is “00” for the cooking mode, the microcomputer 20 interprets that the cooking process is performed using microwaves. When the read bar code is “00 001 111” for the cooking time, the microcomputer 20 interprets that the cooking process is performed for 50 seconds. When the read bar code is “001” for the power level, the microcomputer 20 interprets that the cooking process is performed at 20% of the total power level.

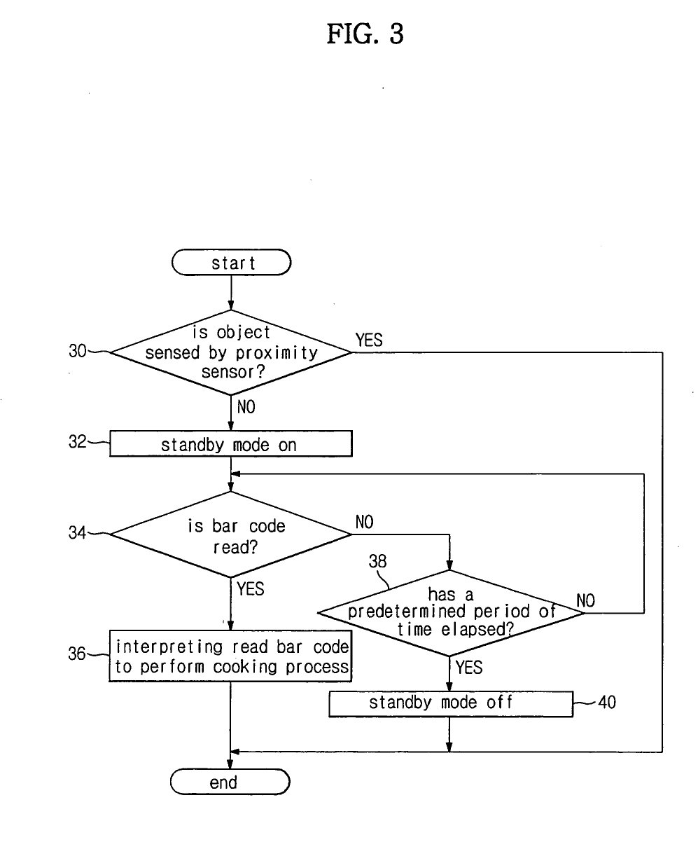

FIG. 3 is a flowchart illustrating a cooking process performed in the microwave oven shown in FIG. 2. In FIG. 3, at operation 30, the microcomputer 20 determines whether an object is sensed by the proximity sensor 16. When it is determined in operation 30, that no object is sensed, the cooking process is ended. When it is determined in operation 30, that the object is sensed by the proximity sensor 16, the process moves to operation 32 where the microcomputer 20 interprets that a user brings a bar code printed on a food package to the bar-code reader 14 or a user brings the bar-code reader 14 to a bar code printed on a food package in the case of the external bar-code reader 14, and turns the bar-code reader 14 on so that the bar-code reader 14 enters a standby mode. The standby mode is a mode to keep the bar-code reader 14 in a state wherein it can read the bar code.

While in the standby mode, the process moves to operation 34, where the microcomputer 20 determines whether the bar code is read by the bar-code reader 14. When it is determined in operation 34, that the bar code is read by the bar-code reader 14, the process moves to operation 36, where the microcomputer 20 interprets the read bar code to perform the cooking process on the basis of the cooking information (cooking mode, cooking time, and power level) stored in the interpreted bar code.

When it is determined in operation 34 that the bar code is not read, the process moves to operation 38, where the microcomputer 20 determines whether a predetermined period of time elapses since entering the standby mode. When it is determined in operation 38, that the predetermined period of time has not elapsed since entering the standby mode, the process returns to operation S34. When it is determined in operation 38, that the predetermined period of time elapses, the process moves to operation 40, where the microcomputer 20 turns the standby mode off.

As is described above, when the bar code is not read for a predetermined period of time after the standby mode is on, the microcomputer 20 determines that any object, other than a food package with a bar code printed thereon, approaches the bar-code reader 14, and thus turns the standby mode off to prevent the bar-code reader 14 from being kept on.

The present invention provides a cooking apparatus that is capable of automatically turning a bar-code reader on to read a bar code when a food package with a bar code printed thereon approaches the bar-code reader. Consequently, the present invention has the effect of improving convenience of use.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A cooking apparatus comprising:
a bar-code reader to read a bar code;
an object-sensing unit to sense an object around the bar-code reader; and
a control unit to perform a controlling operation of the cooking apparatus, wherein the bar-code reader is turned on and enters a standby mode when the object is sensed by the object-sensing unit.

2. The apparatus according to claim 1, wherein the object-sensing unit is disposed at the bar-code reader or adjacent to the bar-code reader.

3. The apparatus according to claim 1, wherein the bar-code reader reads the bar code when the barcode is brought to the bar-code reader in the standby mode, and the control unit performs a controlling operation of the cooking apparatus, wherein a cooking process is carried out based upon the cooking information of the read bar code.

4. The apparatus according to claim 1, wherein the control unit turns the standby mode off when the bar code is not read by the bar-code reader for a predetermined period of time after entering the standby mode.

5. A cooking apparatus comprising:
a bar-code reader to read a bar code;
a proximity sensor to sense an object approaching the bar-code reader; and
a control unit to turn the bar-code reader on when the object is sensed by the proximity sensor.

6. The apparatus according to claim 5, wherein the proximity sensor is disposed at the bar-code reader or adjacent to the bar-code reader.

7. The apparatus according to claim 5, wherein the control unit turns the bar-code reader off when the bar code is not read by the bar-code reader for a predetermined period of time after the bar-code reader is turned on.

8. The apparatus according to claim 5, wherein the proximity sensor comprises one of an infrared sensor or an ultrasonic sensor.

9. A method comprising:
sensing an object around a bar-code reader; and
allowing the bar-code reader to enter a standby mode when the object is sensed around the bar-code reader.

10. The method according to claim 9, wherein the bar-code reader reads the bar code when the bar code is brought to the bar-code reader in the standby mode.

11. The method according to claim 9, wherein the standby mode is turned off when the bar code is not read by the bar-code reader for a predetermined period of time after entering the standby mode.

12. A cooking apparatus comprising:
a bar-code reader connected with an exterior of the cooking apparatus, to read a bar code;
a sensor to sense the bar code approaching the bar-code reader; and
a control unit to turn on the bar-code reader when the bar code is sensed by the sensor.

13. The cooking apparatus according to claim 12, wherein the bar-code reader comprises a reading window, and the sensor is disposed adjacent to the reading window.

14. The cooking apparatus according to claim 12, wherein the bar-code reader comprises one of a charge-coupled display type or pen-type bar-code reader connected with the cooking apparatus via a cable.

15. The cooking apparatus according to claim 12, wherein the control unit turns the bar-code reader off after a predetermined period of time, when the bar-code reader has not read a bar code.
